(19) United States
(12) Patent Application Publication
(10) Pub. No.: US 2006/0084322 A1
(43) Pub. Date: Apr. 20, 2006

(54) Electrical outlet assembly

(75) Inventor: Harald Opolka, Solingen (DE)

Correspondence Address: THE FIRM OF KARL F ROSS, 5676 RIVERDALE AVENUE, PO BOX 900, RIVERDALE (BRONX), NY, 10471-0900, US

(73) Assignee: ZWEIBRUDER OPTOELECTRONICS GMBH

(21) Appl. No.: 11/234,036

(22) Filed: Sep. 23, 2005

(30) Foreign Application Priority Data
Oct. 15, 2004 (DE) 202004016090.0

(51) Int. Cl. H01R 25/00

(52) U.S. Cl. 439/652

(57) ABSTRACT

An outlet strip having a multiplicity of outlets in a housing with a foot switch connected with the housing through a relatively long conductor, usually with a length of at least 0.5 m, to allow that foot switch to turn off and on all of the outlets of the strip.

### FIELD OF THE INVENTION

The present invention relates to electrical outlet assembly and, more particularly, to a multiple outlet unit having a foot switch. More specifically, the invention relates to an outlet strip having a foot switch connected thereto to control the multiple outlets of that strip.

### BACKGROUND OF THE INVENTION

Multiple outlet units are generally known in the art and are so widely used that practically every household has one. Outlet strips are generally provided in the form of a housing having 2, 3 or more outlets and serve to supply multiple electrical devices with electric current. Such an outlet strip generally has a cable or conductor with a plug at the end and can serve as an extension to operate electrical devices remote from a house outlet into which the strip is plugged.

To switch the devices which in turn are plugged into the various outlets of an outlet strip on and off, the devices generally have their own switches. Frequently it is desirable to be able to switch off all of the devices connected to a multiple outlet strip, either for convenience or to save current or on safety grounds during vacations or absences of the householder. Multiple strips have therefore been provided with switches which can control all of the outlets of the strip.

However, since the outlet strips may themselves be located behind furniture or at other places to which access is not readily afforded, the switch on the housing of the outlet strip may not be accessible or may be difficult to reach and thus, in practice, the switch on the outlet strip may not be used. Furthermore, in most commercially available outlet strips the switch may be located at the end of or side of the housing into which the current supply cable runs. This arrangement is convenient to wire. However, it may not be convenient to operate.

Mention may also be made of the fact that DE 202 10 872 U1 describes an outlet strip having a foot switch built onto the housing and which is located at the side of the housing opposite that at which the cable enters the housing. This system has the advantage that the outlet strip can be placed beneath an article of furniture so that its cable will not be visible but with the end of the housing positioned so that the switch can be operated by the foot of the user. In practice, this arrangement has not been found fully satisfactory either and, for example, furniture with overhangs may prevent operation of the switch.

### OBJECTS OF THE INVENTION

It is therefore the principal object of the present invention to provide an improved electrical outlet assembly whereby these drawbacks are avoided and in particular a multiple outlet system can be provided which can be used more simply and conveniently.

Another object of this invention is to provide an electrical outlet assembly which is more convenient to operate than earlier devices.

### SUMMARY OF THE INVENTION

These and other objects which will become apparent hereinafter are attained, in accordance with the invention in an electrical outlet assembly, especially a multiple outlet strip, which comprises a housing, preferably an elongated housing, a multiplicity of separate plug-receiving outlets in the housing and a foot switch connected by a flexible conductor with the housing for switching the multiplicity of outlets.

Thus with the outlet strip of the present invention, the foot switch is connected by a conductor or cable with the housing having a multiplicity of separate outlets. In accordance with the invention the switch is separated from the housing. The switch can thus be located independently of the location, orientation and position of the multiple outlet unit and independently from the location of the connection of the outlet strip to the power network. This enables greater flexibility and simplified handling of the outlet strip and the switching on and off of the outlets thereof. The switch can be located by the user at a convenient position for use and can occupy space which is much smaller than that occupied by the strip and without concern for the orientation or location of the strip. Preferably the conductor or cable between the foot switch and the housing has a length of at least 0.5 m to enable a large spacing between the outlet strip and the switch.

Preferably the foot switch is a pressure switch with an actuator which is displaceable perpendicular to a support surface for the foot switch. This direction can be vertical when the foot switch is placed upon a horizontal surface like a floor. The vertically displaceable pressure switch has an advantage over switches which operate by a tilting action and which may not easily be tripped by the foot of the user.

In one embodiment of the invention the pressure switch is provided in the current supply cable at a distance of at least 0.5 m from the housing of the strip and on an opposite end of this cable, the plug can be provided through which the strip is supplied with current. Preferred however is an embodiment in which the foot switch is connected by a separate line or cable to the housing of the strip. The separate line enables the positioning of the foot switch completely independently from the position of the strip housing and the current supply cable. For example, the housing and current supply cable can be provided behind a closet wall or an article of furniture while the pressure switch can be exposed and accessible. The housing can practically be located anywhere that is convenient if the line connecting it with the foot switch is sufficiently long.

The pressure switch can be provided with a double-sided adhesive tape, covered by a strippable foil so that, if desired the pressure switch can be mounted on a wall or furniture surface which is not horizontal or on the underside of a table. In this case the switch may be operated by hand.

In the case in which the pressure switch may be placed on a smooth floor, for example a parquet floor or a tile floor, it can have an underside of rubber or some other nonslip material so that even the application of force laterally will not materially displace it.

The housing can have slit-like openings through which the power cable and/or the switch cable can be passed and the slit can run to the bottom of the housing, thereby permitting the cable to be oriented close to the bottom or elsewhere for convenience in mounting or positioning and preferably each side of the housing can have such a slit or passthrough for the cable.

The device enables complete shutdown of all of the electrical units connected to it, thereby eliminating the need or possibility of a stand-by mode for electrical appliances in a manner consistent with regulatory requirements which frown on stand-by status for many electrical devices.

### BRIEF DESCRIPTION OF THE DRAWING

The above and other objects, features, and advantages will become more readily apparent from the following description, reference being made to the accompanying drawing in which:

FIG. 1 is a diagrammatic elevational view of a portion of an outlet strip in accordance with the present invention;

FIG. 2 is a view similar to FIG. 1 of a different embodiment;

FIG. 3 is a circuit diagram illustrating the principles of the embodiment of FIG. 2;

FIG. 4 is a circuit diagram illustrating the principles of the embodiment of FIG. 1;

FIG. 5 is a perspective view illustrating a feature of the invention with respect to the mounting of the outlet strip;

FIG. 6 is a bottom view of the housing of an outlet strip in accordance with the invention;

FIG. 7 is a bottom view of the foot switch; and

FIG. 8 is a perspective view of a portion of the outlet strip showing a feature of the invention.

### SPECIFIC DESCRIPTION

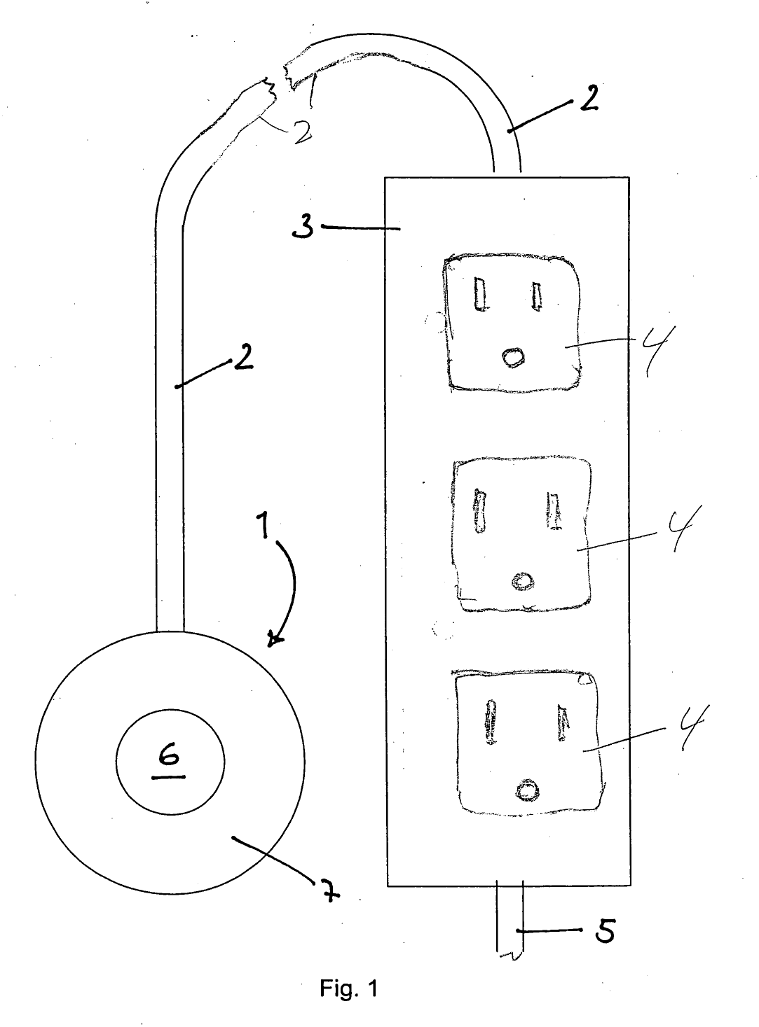

The outlet assembly of FIG. 1 comprises a housing 3 forming an outlet strip having three outlets 4 arranged in a row and supplied with electric current by the current supply cable 5. The cable 5 has a plug, not shown, which can be inserted in the usual 110 volt outlet of a home, office or like location. The other end of the current supply cable 5 terminates in the housing 3.

On the opposite end of the housing 3, a switch conductor or cable 2 extends to a foot switch 1. The foot switch 1 in the embodiment illustrated, comprises a switch housing 7 and an actuator 6 which is centrally located in the housing 7 and operates a switch against a spring force in a direction perpendicular to the support surface of the housing 7. This form of the foot switch enables it to be operated particularly simply by the foot.

In the embodiment illustrated, the cables 2 and 5 extend from opposite ends of the housing. This can, of course, extend from the same side of the housing as well. The underside of the housing 7 can be provided with a nonslip, e.g. rubber layer.

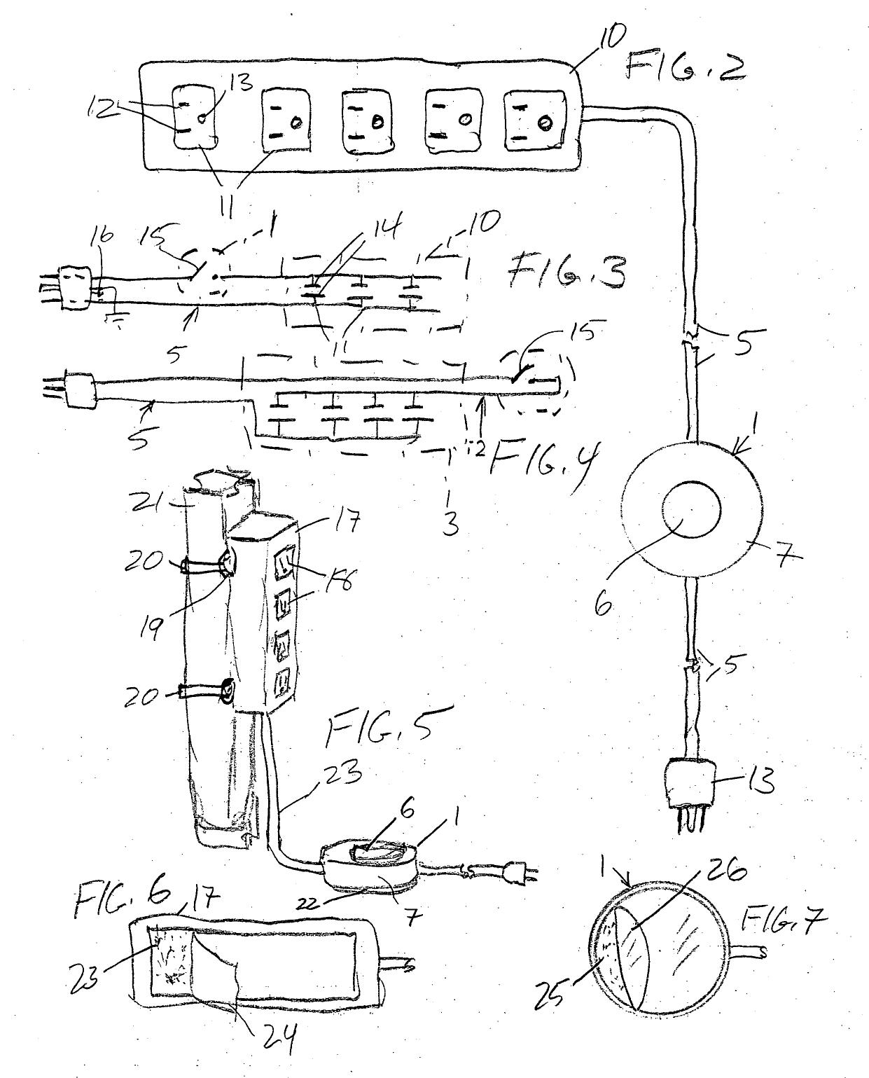

In the embodiment of FIG. 2, the foot switch 1 with its actuator 6 and housing 7 is located directly in the power cable 5 which is connected to the housing 10 with its outlets 11. The outlets 4 and 11 each have two slots 12 to receive the prongs of a standard plug and a hole 13 for the ground prong. In FIG. 2, moreover, the plug 13 which can be inserted into a standard wall outlet has also been shown.

As can be seen from FIG. 3, the contacts 14 of each outlet 11 are connected in series with the contact switch 15 of the foot switch 1 which is located in the power cable 5. The ground conductor 16 of the cable can be connected to the ground terminals of the outlets which have not been shown in FIG. 3.

In the embodiment of FIG. 4, the switch contacts 15 are shown to be connected in the switch conductor 2 rather than in the power cable 5.

From FIG. 5 it will be apparent that the housing 17 of the outlet strip, provided with the outlets 18 can have eyes 19 through which these bands may be passed to mount the outlet strip on, for example a leg 21 of an article of furniture while the foot switch 1, with its nonslip layer 22 can rest on the floor. Here the foot switch 1 is in the power cable 23.

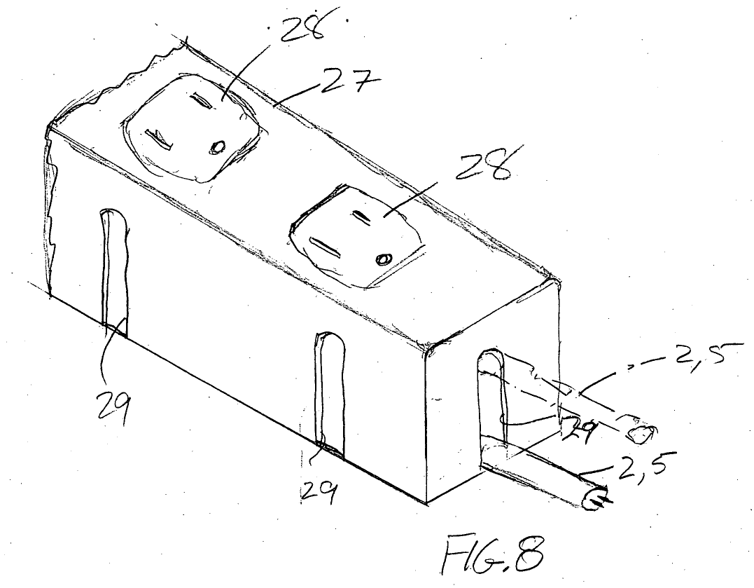

FIG. 6 shows that the housing 17 may, alternatively or in addition, be provided with a double-face adhesive tape 23 from which the masking foil 24 can be stripped to expose an adhesive surface allowing the outlet strip to be secured to a wall or an article of furniture or the like.

In FIG. 7, the foot switch 1 is shown to have on its underside a double-face adhesive tape 25 from which the masking foil 26 can be stripped to allow mounting of the pressure switch on the underside of a desk or other article of furniture.

From FIG. 8 it can be seen that an outlet housing 27 with the outlet 28 operated by a foot switch can be formed with slits or slots 29, preferably along each side through which the cables 2 or 5 can be selectively passed so that these cables can extend in any desired direction from the housing and assume practically any position as represented by a comparison of the dot-dash positions and the solid line position of the cable in FIG. 8.

1. An electrical outlet assembly comprising:
a housing;
a multiplicity of separate plug-receiving outlets in said housing;
a depression-type foot switch connected by a flexible conductor with said housing for switching said multiplicity of outlets; and
an attachment element formed on said housing for securing said housing to a support surface.

2. The electrical outlet assembly defined in claim 1 wherein said flexible conductor has a length of at least 0.5 m.

3. The electrical outlet assembly defined in claim 2 wherein said foot switch comprises a switch body having a support surface, and an actuator displaceable perpendicularly to said support surface.

4. The electrical outlet assembly defined in claim 1, further comprising a current-supply cable having a plug connected to said housing for energizing said multiplicity of outlets.

5. The electrical outlet assembly defined in claim 4 wherein said foot switch is located along said cable between said plug and said housing.

6. The electrical outlet assembly defined in claim 4 wherein said flexible conductor is a cable separate from said current-supply cable and said foot switch is connected to said housing by said flexible conductor separately from said current-supply cable and is located at an end of said flexible conductor.

7. The electrical outlet assembly defined in claim 1 wherein said foot switch has a surface provided with a double-side adhesive layer covered by a strippable masking foil to enable adhesive securing of the foot switch to a surface.

8. The electrical outlet assembly defined in claim 1 wherein said foot switch has a surface provided with a slip-resistant layer.

9. The electrical outlet assembly defined in claim 1 wherein said housing has at least one side wall provided with a slit-shaped opening through which a conductor can be passed.

10. (canceled)

11. The electrical outlet assembly defined in claim 1 wherein said attachment element is a double-side adhesive layer covered by a strippable masking foil.

12. The electrical outlet assembly defined in claim 1 wherein said attachment element is a band passing through eyes on said housing.
